(19) United States
(12) Patent Application Publication
(10) Pub. No.: US 2026/0370279 A1
(43) Pub. Date: Nov. 19, 2026

(54) TRANSMISSION AND RECEPTION OF A TWO-DIMENSIONAL PILOT SIGNAL

(71) Applicant: Telefonaktiebolaget LM Ericsson (publ), Stockholm (SE)

(72) Inventors: Behrooz MAKKI, Pixbo (SE); Fazal E ASIM, Fortaleza (BR); Bruno SOKAL, Fortaleza (BR); André L. F. DE ALMEIDA, Fortaleza (BR); Gabor FODOR, Hässelby (SE)

(73) Assignee: Telefonaktiebolaget LM Ericsson (publ), Stockholm (SE)

(21) Appl. No.: 19/135,549

(22) PCT Filed: Dec. 6, 2022
(86) PCT No.: PCT/EP2022/084677

§ 371 Date: Jun. 4, 2025

(51) Int. Cl. H04B 7/06; H04L 27/26

(52) U.S. Cl. CPC H04B 7/0613; H04L 27/2602

(57) ABSTRACT

There is provided techniques for transmitting a two-dimensional pilot signal. A method is performed by a network node. The method comprises generating the two-dimensional pilot signal by spreading an azimuth domain pilot sequence with an elevation domain pilot sequence in the elevation domain and spreading the elevation domain pilot sequence with the azimuth domain pilot signal pilot sequence in the azimuth domain. The method comprises transmitting the two-dimensional pilot signal over the air.

### TECHNICAL FIELD

Embodiments presented herein relate to a method, a network node, a computer program, and a computer program product for transmitting a two-dimensional pilot signal. Embodiments presented herein further relate to a method, a user equipment, a computer program, and a computer program product for receiving a two-dimensional pilot signal.

### BACKGROUND

In general terms, pilot signals comprise pilot sequences and can be used for many different purposes in wireless communication system. For example, pilot signals can used for channel parameter estimation and tracking of user equipment (UE) in a cell. Pilot signals can, as well, act as reference signals communicated between a network node at the network-side and UEs at the user-side. Such reference signals can, for instance, be utilized for initial access, synchronization, etc.

The pilot signals are transmitted over a wireless channel in the wireless communication system. The pilot signals are thereby impacted by properties of the wireless channel itself, such as noise and fading, as well as properties, for example reflections, caused by the physical environment in which the pilot signals are communicated. As is known in the art, there can be different types of wireless channels as well as physical environments in which a wireless communication system is deployed, each with its own challenges. As a non-limiting and illustrative example, considering a channel estimation procedure in an IRS-assisted network, where IRS is short for intelligent reflective surface. In short, an IRS is composed of a 2-dimensional array of reflecting elements, where each element acts as a passive reconfigurable scatterer, i.e., a piece of manufactured material, which can be programmed to change an impinging electro-magnetic wave in a customizable way. Such elements are usually low-cost passive surfaces that do not require dedicated power sources, and the radio waves impinged upon them can be forwarded without the need of employing power amplifier or radio-frequency (RF) chain. The network node can then transmit pilot signals to the UE via the IRS. The UE then estimates the downlink channel matrix based on the received pilot signals and feeds the downlink channel matrix back to the network node (possibly via the IRS) for precoding design. In millimeter-wave (mmWave) and terahertz (THz) communications, the use of large antenna arrays (e.g., composed of tens to hundreds of elements) as well as several hundreds of reflecting elements used in the IRS makes the design of pilot signals a challenging task. Ensuring orthogonal pilot sequences implies transmitting pilot signals composed of long sequences, thereby sacrificing system spectral efficiency.

The design of pilot sequences does not exploit the geometry of the transmit and receive antenna arrays. In addition, at the receiver, the channel matrix is commonly estimated by solving a single optimization problem using, e.g., least squares (LS) or minimum mean square error (MMSE), methods.

Hence, there is a need for an improved design of pilot signals.

### SUMMARY

An object of embodiments herein is to design pilot signals such that the above issues can be avoided, or at least reduced or mitigated.

According to a first aspect there is presented a method for transmitting a two-dimensional pilot signal. The method is performed by a network node. The method comprises generating the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y. The method comprises transmitting the two-dimensional pilot signal over the air.

According to a second aspect there is presented a network node for transmitting a two-dimensional pilot signal. The network node comprises processing circuitry. The processing circuitry is configured to cause the network node to generate the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y. The processing circuitry is configured to cause the network node to transmit the two-dimensional pilot signal over the air.

According to a third aspect there is presented a network node for transmitting a two-dimensional pilot signal. The network node comprises a generate module configured to generate the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y. The network node comprises a transmit module configured to transmit the two-dimensional pilot signal over the air.

According to a fourth aspect there is presented a computer program for transmitting a two-dimensional pilot signal. The computer program comprises computer code which, when run on processing circuitry of a network node, causes the network node to perform actions. One action comprises the network node to generate the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y. One action comprises the network node to transmit the two-dimensional pilot signal over the air.

According to a fifth aspect there is presented a method for receiving a two-dimensional pilot signal. The method is performed by a UE. The method comprises receiving the two-dimensional pilot signal X over the air from a network node. The method comprises de-spreading the two-dimensional pilot signal X and estimating a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

According to a sixth aspect there is presented a UE for receiving a two-dimensional pilot signal. The UE comprises processing circuitry. The processing circuitry is configured to cause the UE to receive the two-dimensional pilot signal X over the air from a network node. The processing circuitry is configured to cause the UE to de-spread the two-dimensional pilot signal X and estimate a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

According to a seventh aspect there is presented a UE for receiving a two-dimensional pilot signal. The UE comprises a receive module configured to receive the two-dimensional pilot signal X over the air from a network node. The UE comprises an estimate module configured to de-spread the two-dimensional pilot signal X and estimate a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

According to an eighth aspect there is presented a computer program for receiving a two-dimensional pilot signal.

The computer program comprises computer code which, when run on processing circuitry of a UE, causes the UE to perform actions. One action comprises the UE to receive the two-dimensional pilot signal X over the air from a network node. One action comprises the UE to de-spread the two-dimensional pilot signal X and estimate a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide pilot signals that enables the above issues to be avoided, or at least reduced or mitigated.

Advantageously, these aspects enable the overall computational complexity at the receiver side to be reduced. This is achieved by decoupling the channel estimation problem into two parallel and smaller problems.

Advantageously, these aspects enable a flexible transmission design of transmissions by allowing to decouple pilot and data transmissions along azimuth and elevation domains.

Advantageously, these aspects enable the lengths of the pilot sequences to be relaxed. Consequently, compared to existing methods, the computational complexity can be significantly reduced both at the transmitter side and at the receiver side.

Advantageously, these aspects are applicable to different types of wireless communication systems, such as wireless communication systems having one or more IRS or network-controlled repeater (NCR), or wireless communication systems based on massive multiple input multiple output (mMIMO) techniques, or line of sight (LOS) MIMO techniques.

Advantageously, these aspects enable pilot signals and data to be transmitted in different domains, thereby increasing the spectral efficiency compared to state-of-the-art pilot and data transmission strategies.

Advantageously, these aspects enable channel variations in azimuth and elevation to be tracked independently.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 and 2 are schematic diagrams illustrating communication systems according to embodiments;

FIG. 3 is a block diagram of a network node according to embodiments;

FIGS. 4 and 5 are flowcharts of methods according to embodiments;

FIGS. 6 and 7 are schematic illustrations of a network node and a UE in a coordinate system according to embodiments;

FIGS. 8 and 9 show simulation results according to embodiments;

FIG. 10 is a signalling diagram of a method according to an embodiment;

FIG. 11 is a flowchart of a method according to an embodiment;

FIG. 12 is a schematic diagram showing functional units of a network node according to an embodiment;

FIG. 13 is a schematic diagram showing functional modules of a network node according to an embodiment;

FIG. 14 is a schematic diagram showing functional units of a UE according to an embodiment;

FIG. 15 is a schematic diagram showing functional modules of a UE according to an embodiment; and

FIG. 16 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

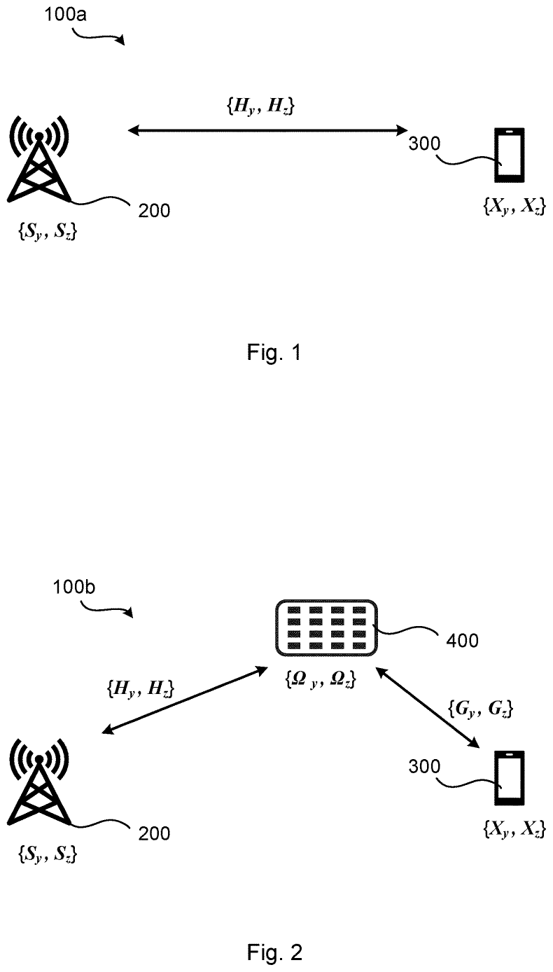

Consider a wireless communication system 100a as illustrated in FIG. 1 in which a network node 200 is communicating with a UE 300 over a wireless channel. The network node 200 might be any of a radio access network node, radio base station, base transceiver station, node B (NB), evolved node B (eNB), gNB, access point, access node, integrated access and backhaul node. The UE 300 might be any of a portable wireless device, mobile station, mobile phone, handset, wireless local loop phone, smartphone, laptop computer, tablet computer, wireless modem, wireless sensor device, Internet of Things device, network equipped vehicle.

For illustrative purposes it is assumed that the network node 200 is equipped with a unform rectangular (antenna) array (URA) having M_{y} antenna elements in the azimuth domain (i.e., along the horizontal axis) and M_{z} antenna elements along in the elevation domain (i.e., along the vertical axis), thus with a total number of antenna elements M=M_{y}M_{z}. Similarly, the UE 300 is assumed to be equipped with a URA having Q_{y} antenna elements in the azimuth domain and with Q_{z} antenna elements in the elevation domain, thus with a total number of antenna elements Q=Q_{y}Q_{z}. Therefore, the network node 200 and the UE 300 cane be assumed to communicate over a wireless MIMO channel characterized by a channel matric H∈ [symbol] ^{M×Q}.

Consider a wireless communication system 100b as illustrated in FIG. 2 in which a network node 200 is communicating with a UE 300 over a wireless channel via an IRS 400. The network node 200 and the UE 300 are assumed to be configured in the same way as in FIG. 1. Assume that the IRS 400 is composed of N_{y} reflecting elements in the azimuth domain (i.e., along the horizontal axis) and N_{z} reflecting elements in the elevation domain (i.e., along the vertical axis), thus having a total of N=N_{y}N_{z}. Let G∈ [symbol] ^{Q×N} be the MIMO channel between the network node 200 and the IRS 400, let H∈ [symbol] ^{N×M} be the MIMO channel matrix between the IRS 400 and the UE 300, and let Ω∈ [symbol] ^{N×N} be the diagonal matrix holding the phase-shifts of the IRS reflecting elements.

In line-of-sight (LOS) scenarios, or non-line-of-sight (NLOS) scenarios having a dominant LOS component, i.e., a higher Rician K-factor, the MIMO propagation channel can be well approximated as the Kronecker product of the horizontal and vertical components, i.e., H=H_{y}⊗H_{z} and G=G_{y}⊗G_{z}, where “⊗” denotes the Kronecker product operator. This is particularly the case in mmWave and Terahertz communications. This Kronecker approximation model is also valid when in a multipath wireless channel, the angular spread in one domain is negligible compared to the angular spread in the other domain.

As disclosed above, there is a need for an improved design of pilot signals.

In further detail, during a certain time frame, the wireless channel may show more variations in one domain as compared to the other domain. Even if the two end-points of the wireless channel, i.e., the network node 200 and the UE 300 are at fixed positions, still in most of the cases, one of the domains might show lower variations (angular spread) as compared to the other. Moreover, when the number of antenna elements is large, such as in massive multiple-input-multiple-output (MIMO) setups or in IRS-assisted networks with a large number of IRS elements, the estimation of the channel parameters relies on a single pilot sequence, the design of which may be challenging due to the large number of antenna elements at the network node 200 and/or large number of reflecting elements at the IRS 400.

Additionally, the IRS 400 is not capable of estimating the wireless channel; only the UE 300 or the network node 200 are. The pilot sequences specified in 3GPP TS 38.211 “NR; Physical channels and modulation”, version 17.3.0, such as pseudo-random (PR) sequences and Zadoff-Chu sequences, do not exploit the separable geometrical structure of the antenna arrays. State of the art design of pilot signals usually implies transmitting a different (possible orthogonal) training sequence at each transmit antenna. Furthermore, existing pilot signal design strategies do not exploit the non-uniform behavior of the wireless channel across the horizontal (azimuth) and the vertical (elevation) domains. Not exploiting the wireless channel structure can lead to inefficient use of spectral resources.

At least some of the herein disclosed embodiments therefore propose a pilot signal design strategy that effectively exploits the geometry of uniform rectangular arrays (URA) to decouple the channel parameter estimation and tracking problem into azimuth and elevation domain sub-problems. The elevation domain is associated with the elevation spatial frequencies whilst the azimuth domain is associated with the azimuth spatial frequencies. The pilot sequences can be designed independently for the azimuth and the elevation domains, respectively. As will be explained in more detail below, the final transmitted pilot signal is spread in both the azimuth domain and the elevation domain. By jointly factorizing the pilot sequence, the receiver can split the channel estimation problem into two smaller (and independent) sub-problems: one for the azimuth (horizontal) domain and one for the elevation (vertical) domain.

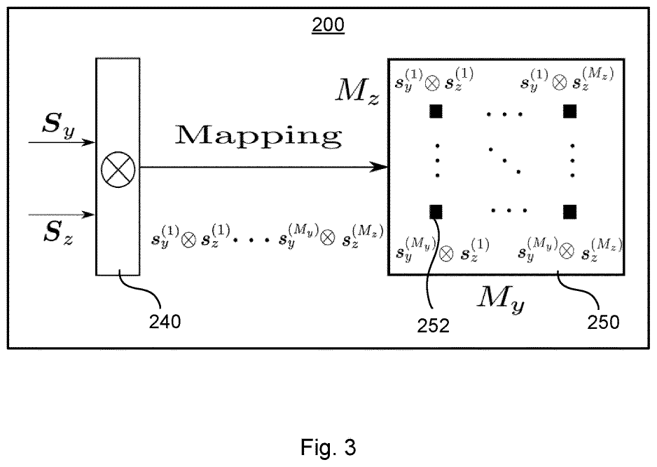

Reference is here made to FIG. 3 in which is illustrated a block diagram of a network node 200 according to embodiments. A combination, as obtained by passing two independent pilot sequences,

$${s}_{y}^{( i )}$$

along the azimuth domain and

$${s}_{z}^{( j )}$$

along the elevation domain that are the columns of

$${S}_{y} = [ {s}_{y}^{( 1 )} , … , {s}_{y}^{( {M}_{y} )} ] and {S}_{Z} = [ {s}_{z}^{( 1 )} , … , {s}_{z}^{( {M}_{z} )} ]$$

through a combiner 240, is mapped to the antenna elements (one of which is identified at 252) in an antenna array 250 of the network node 200. In the example of FIG. 3, the Kronecker product is used as an example of how the pilot sequences can be mapped to the antenna elements so that the pilot sequences are combined and spread in the azimuth domain and the elevation domain.

With this, the complexity of a large estimation problem is significantly reduced to that of two smaller sub-problems. Moreover, the proposed independent pilot signal designs in the azimuth and elevation domains significantly reduce the constraints on the length of the pilot sequences. In some embodiments, such a decoupling also helps in the transmission of joint pilot signals and data due to the nature of variations of the wireless channel along the azimuth and elevation domains. The network node can transmit more pilot signals along the domain (azimuth or elevation) which shows more variations as compared to the other domain (elevation or azimuth) which may be used (only) for data transmission.

The embodiments disclosed herein in particular relate to techniques for transmitting a two-dimensional pilot signal and receiving a two-dimensional pilot signal. In order to obtain such techniques there is provided a network node 200, a method performed by the network node 200, a computer program product comprising code, for example in the form of a computer program, that when run on processing circuitry of the network node 200, causes the network node 200 to perform the method. In order to obtain such techniques there is further provided a UE 300, a method performed by the UE 300, and a computer program product comprising code, for example in the form of a computer program, that when run on processing circuitry of the UE 300, causes the UE 300 to perform the method.

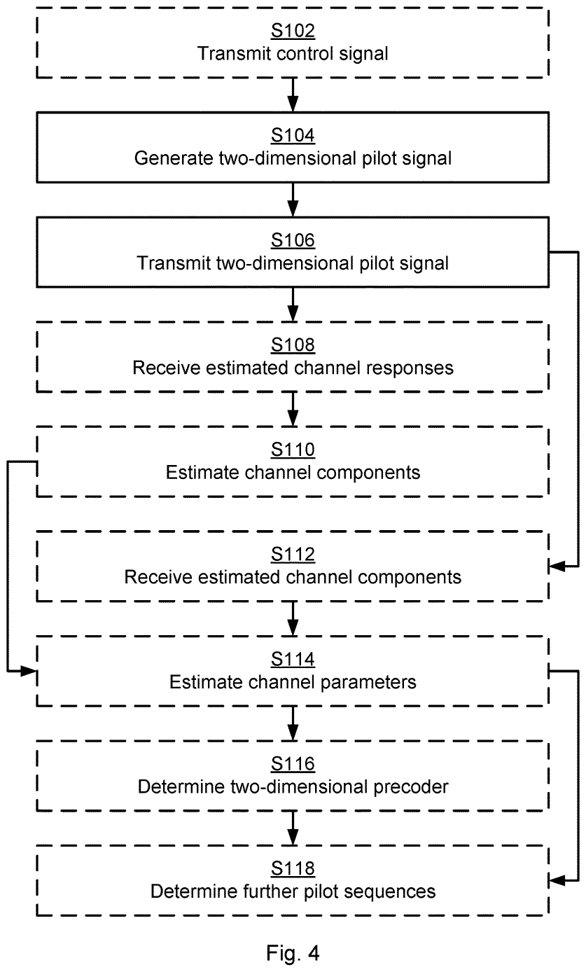

Reference is now made to FIG. 4 illustrating a method for transmitting a two-dimensional pilot signal as performed by the network node 200 according to an embodiment.

S104: The network node 200 generates the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y.

S106: The network node 200 transmits the two-dimensional pilot signal over the air.

As a result, a different combination of azimuth and elevation pilot sequences are transmitted at each antenna element at the network node 200.

In general terms, the two-dimensional pilot signal S is assumed to be transmitted towards the UE 300.

Embodiments relating to further details of transmitting a two-dimensional pilot signal as performed by the network node 200 will now be disclosed with continued reference to FIG. 4.

In some embodiments, the azimuth domain pilot sequence S_{y} is designed independently from the elevation domain pilot sequence S_{z}.

If the wireless channel is to be estimated at the UE 300 then the network node 200 needs to share the azimuth and elevation domain pilot sequences (as well as the length of the pilot signal) with the UE 300 via some control signal. Therefore, in some embodiments, the network node 200 is configured to perform (optional) step S102.

S102: The network node 200 transmits a control signal to configure the UE 300 with the azimuth domain pilot sequence S_{y} and the elevation domain pilot sequence S_{z} prior to transmitting the two-dimensional pilot signal.

If the wireless channel is to be estimated at the network node 200 then the network node 200 needs only to share the length of the pilot signal with the UE 300 via some control signal.

It is next assumed that the wireless channel is to be estimated at the network node 200. As will be further disclosed below, the UE 300 will estimate the azimuth domain channel component Ĥ_{y} and the elevation domain channel component Ĥ_{z} from the two-dimensional pilot signal as received by the UE 300. Hence, in some embodiments, the network node 200 is configured to perform (optional) step S108.

S108: The network node 200 receives an estimated azimuth domain channel component Ĥ_{y} and an estimated elevation domain channel component Ĥ_{z} over the air from the UE 300.

From the estimated matrices \hat{X}_{y} and \hat{X}_{z}, and from the knowledge of the transmitted pilot sequences, i.e., S_{y}, S_{z}, the network node can then obtain decoupled estimates of the horizontal (as defined by Ĥ_{y}) and the vertical (as defined by Ĥ_{z}) components. Particularly, in some embodiments, the network node 200 is configured to perform (optional) step S110.

S110: The network node 200 estimates an azimuth domain channel component Ĥ_{y} from the estimated azimuth domain pilot sequence \hat{X}_{y} and an elevation domain channel component Ĥ_{z} from the estimated elevation domain pilot sequence \hat{X}_{z}.

It is next assumed that the wireless channel is to be estimated at the UE 300, and thus that the network node 200 has shared the azimuth and elevation domain pilot sequences (as well as the length of the pilot signal) with the UE 300 via some control signal. In this case, the UE 300 feeds back Ĥ_{y} and Ĥ_{z} to the network node 200. That is, in some embodiments, the network node 200 is configured to perform (optional) step S112.

S112: The network node 200 receives an estimated azimuth domain channel component Ĥ_{y} and an estimated elevation domain channel component Ĥ_{z} over the air from the UE 300.

Regardless if the wireless channel was estimated at the UE 300 or at the network node 200, the network node 200 can use these estimated channel matrices to further estimate the channel parameters. That is, in some embodiments, the network node 200 is configured to perform (optional) step S114.

S114: The network node 200 estimates azimuth domain channel parameters from the estimated azimuth domain channel component Ĥ_{y} and estimates elevation domain channel parameters from the estimated elevation domain channel component Ĥ_{z}.

In some aspects, the azimuth and elevation domain channel parameters are used to design a two-dimensional precoder, or beamformer, consisting of horizontal and vertical components In particular, in some embodiments, the network node 200 is configured to perform (optional) step S116.

S116: The network node 200 determines a two-dimensional precoder with an azimuth component determined from the estimated azimuth domain channel parameters and an elevation component determined from the estimated elevation domain channel parameters.

In this respects, there are at least two ways in which the two-dimensional precoder can be designed. According to a first example, singular value decomposition (SVD) is applied to Ĥ_{y} and Ĥ_{z} to design an optimal precoder.

According to a second example, first the channel parameters are estimated from Ĥ_{y} and Ĥ_{z} and then the optimal precoder is designed based on the channel parameters.

In some aspects, further pilot sequences are allocated in the azimuth and elevation domain in accordance with the channel estimates. The pilot sequence can be selected to be longer in the domain which shows more variations as compared to the other domain. A further two-dimensional pilot signal can then be transmitted. Therefore, in some embodiments, the network node 200 is configured to perform (optional) step S118.

S118: The network node 200 determines a further azimuth domain pilot sequence S_{y} and a further elevation domain pilot sequence S_{z}. The further azimuth domain pilot sequence S_{y} has a length that is proportional to how much the estimated azimuth domain channel parameters vary compared to previously estimated azimuth domain channel parameters. The further elevation domain pilot sequence S_{z} has a length that is proportional to how much the estimated elevation domain channel parameters vary compared to previously estimated elevation domain channel parameters.

This enables the wireless channels to be separately tracked in the two domains.

There can be different ways in which the two-dimensional pilot signal S is generated from the azimuth domain pilot sequence S_{y} and the elevation domain pilot sequence S_{z}. In some examples, the two-dimensional pilot signal S is generated by taking a Kronecker product between the azimuth domain pilot sequence S_{y} and the elevation domain pilot sequence S_{z}. In this respect, the two-dimensional pilot signal S might be transmitted from a two-dimensional antenna comprising antenna element arranged in rows and columns, where the two-dimensional pilot signal

$${s}_{y}^{( i )} ⊗ {s}_{z}^{( j )}$$

is transmitted at antenna element (i, j), where

$${s}_{y}^{( i )} ∈ {S}_{y}$$

is the azimuth domain pilot sequence for all antenna elements in row i of the two-dimensional antenna, where

$${s}_{z}^{( j )} ∈ {S}_{z}$$

is the elevation domain pilot sequence for all antenna elements in column j of the two-dimensional antenna, and where ‘⊗’ denotes the Kronecker product operator.

In some aspects, the network node 200 decides about the allocation of new pilot signals and data to be transmitted along the azimuth and elevation domains towards the UE 300. More specifically, the network node 200 might decide on the ratio of pilot signals and data in each domain. As a non-limiting example, the network node 200 may allocate only pilots in one domain and only data in the other domain to optimize the channel tracking and data transmission simultaneously. That is, in some aspects, depending on the wireless channel variations along azimuth and elevation, the pilot sequences can be transmitted in only one dimension (e.g., in the azimuth domain), whilst data is transmitted in another dimension (e.g., in the elevation domain).

To inform the UE 300 about the pilot and data allocation scheme, the network node 200 might send a control signal towards the UE 300 which determines the operation mode at the UE 300. A first possible operation mode involves channel tracking in both azimuth and elevation domains. A second possible operation mode involves data transmission in both azimuth and elevation domains. A third possible operation mode involves mixed channel tracking and data detection in different domains. The use of such operation modes leads to the decoupling of pilot signals and data transmission into two independent domains for a more flexible system design and optimized data throughput.

In some aspects, the IRS 400 might provide a capability report to the network node 200, informing the network node 200 about, for example, the number and/or the indexing of reflecting elements along azimuth and elevation domains, etc. in the IRS 400.

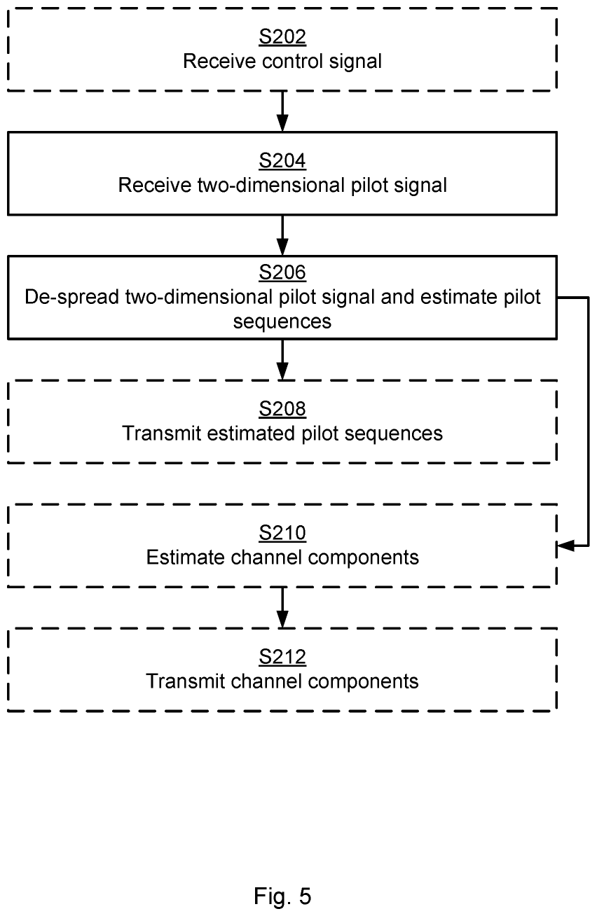

Reference is now made to FIG. 5 illustrating a method for receiving a two-dimensional pilot signal as performed by the UE 300 according to an embodiment.

S204: The UE 300 receives the two-dimensional pilot signal X over the air from the network node 200.

S206: The UE 300 de-spreads the two-dimensional pilot signal X and estimates a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

At the UE 300, the channel estimation is split into two smaller sub-problems, one for the azimuth domain, and one for the elevation domain.

Embodiments relating to further details of receiving a two-dimensional pilot signal as performed by the UE 300 will now be disclosed with continued reference to FIG. 5.

As disclosed above, if the wireless channel is to be estimated at the UE 300 then the network node 200 needs to share the azimuth and elevation domain pilot sequences (as well as the length of the pilot signal) with the UE 300 via some control signal. Therefore, in some embodiments, the UE 300 is configured to perform (optional) step S202.

S202: The UE 300 receives a control signal from the network node 200 to configure the UE 300 with a transmitted azimuth domain pilot sequence S_{y} and a transmitted elevation domain pilot sequence S_{z} prior to receiving the two-dimensional pilot signal.

As further disclosed above, if the wireless channel is to be estimated at the network node 200 then the network node 200 needs only to share the length of the pilot signal with the UE 300 via some control signal.

It is next assumed that the wireless channel is to be estimated at the network node 200. The UE 300 estimates the azimuth domain channel component Ĥ_{y} and the elevation domain channel component Ĥ_{z} from the two-dimensional pilot signal as in S206 and then feeds the estimates back to the network node 200. Hence, in some embodiments, the UE 300 is configured to perform (optional) step S208.

S208: The UE 300 transmits the estimated received azimuth domain pilot sequence \hat{X}_{y} and the estimated received elevation domain pilot sequence \hat{X}_{z} over the air to the network node 200.

It is next assumed that the wireless channel is to be estimated at the UE 300, and thus that the network node 200 has shared the azimuth and elevation domain pilot sequences (as well as the length of the pilot signal) with the UE 300 via some control signal. In this case, the UE 300 is configured to perform (optional) step S210.

S210: The UE 300 estimates an azimuth domain channel component Ĥ_{y} from the estimated received azimuth domain pilot sequence \hat{X}_{y} and an elevation domain channel component Ĥ_{z} from the estimated received elevation domain pilot sequence \hat{X}_{z}.

The UE 300 will then feed back Ĥ_{y} and H̅_{z} to the network node 200. That is, in some embodiments, the UE 300 is configured to perform (optional) step S212.

S212: The UE 300 transmits the estimated azimuth domain channel component Ĥ_{y} and the estimated elevation domain channel component Ĥ_{z} over the air to the network node 200.

As disclosed above, there can be different ways in which the two-dimensional pilot signal S is generated from the azimuth domain pilot sequence S_{y} and the elevation domain pilot sequence S_{z}. In some examples, the two-dimensional pilot signal S is generated by taking a Kronecker product between the azimuth domain pilot sequence S_{y} and the elevation domain pilot sequence S_{z}. Therefore, in some examples, the azimuth domain pilot sequence \hat{X}_{y} and the elevation domain pilot sequence \hat{X}_{z} are estimated from the two-dimensional pilot signal X by Kronecker factorization of the two-dimensional pilot signal X. In some examples, the Kronecker factorization is performed by solving a Kronecker factorization problem formulated as:

$$\{ {\hat{X}}_{y} , {\hat{X}}_{z} \} = {arg min}_{{X}_{y} , {X}_{z}} {‖ X - {X}_{y} ⊗ {X}_{z} ‖}_{F}$$

In some aspects, the UE 300 then estimates the corresponding azimuth and elevation domain channel matrices and feeds them back to the network node 200 for further channel parameter estimation.

There could be different ways to estimate Ĥ_{y} and Ĥ_{z} (regardless if this estimation is performed by the network node 200 or the UE 300). In some examples, a matched filter (MF) approach is used, and thus the azimuth domain channel component Ĥ_{y} and the elevation domain channel component Ĥ_{z} are estimated as:

$$\{ \begin{matrix}{\hat{H}}_{y} = {X}_{y} {S}_{y}^{H} \\ {\hat{H}}_{z} = {X}_{z} {S}_{z}^{H}\end{matrix}$$

Further details relating to the embodiments, aspects and examples as applicable to the above methods will be disclosed next.

$${s}_{y}^{( i )}$$

Assume that the network node 200 generates two independent pilot sequences, along the azimuth domain and

$${s}_{z}^{( j )}$$

along the elevation domain that are the columns of

$${S}_{y} = [ {s}_{y}^{( 1 )} , … , {s}_{y}^{( {M}_{y} )} ] and {S}_{Z} = [ {s}_{z}^{( 1 )} , … , {s}_{z}^{( {M}_{z} )} ]$$

for estimation of the corresponding components of the wireless channel, respectively. Assume that from each antenna element is transmitted a resultant orthogonal pilot sequence that is mapped to the antenna elements according to the Kronecker product between the corresponding columns of S_{y} and S_{z} as shown in FIG. 3 so that at antenna element (i, j), the pilot sequence s_{y}⁽ⁱ⁾⊗s_{z}^{(j)} is transmitted. The received matrix of pilot signals X after the pilot block S=S_{y}⊗S_{z} has been transmitted can then be written as:

X=GωHS+V, (1)

where X∈ [symbol] ^{Q×T} is the received matrix of pilot signals, S∈ [symbol] ^{M×T} is the transmitted matrix of pilot symbol, and V∈ [symbol] ^{Q×T} is a matrix of additive white Gaussian noise. As in FIG. 2, the factor GΩH denotes the wireless channel, with G, Ω, and H as defined above.

Equation (1) can be rewritten by using knowledge of the proposed pilot signal design and considering the channel factorization property as

X=(G_{y}⊗⊗G_{z})(Ω_{y}⊗Ω_{z})(H_{y}⊗H_{z})S_{y}⊗S_{z})+V. (2)

By utilizing that (A⊗B)(C⊗D)=AC⊗BD, Equation (2) yields:

X=(G_{y}Ω_{y}H_{y}S_{y})⊗(G_{z}Ω_{z}H_{z}S_{z})+V (3)

Defining X_{y}=G_{y}Ω_{y}H_{y}S_{y} and X_{z}=G_{z}Ω_{z}H_{z}S_{z} leads to:

X=X_{y}⊗X_{z}+V (4)

According to Equation (4), the received pilot signal is given as the Kronecker product of the azimuth and elevation domain received pilot signals plus additive noise. Hence, decoupled estimates of the vertical and horizontal pilot sequences can be obtained by solving the following least squares (LS) Kronecker factorization problem:

{\hat{X}_{y},\hat{X}_{z}}=arg min∥X−X_{y}⊗X_{z}∥_{F} (5)

The problem in Equation (5) can be efficiently solved as a rank-one matrix approximation problem by means of a truncated singular value decomposition (SVD) using state of the art computation algorithms.

From the estimated matrices \hat{X}_{y} and \hat{X}_{z}, and from the knowledge of the transmitted pilot sequences, i.e., S_{y}, S_{z}, the UE 300 can obtain decoupled estimates of the azimuth and domain components, Ĥ_{y} and Ĥ_{z}. As one non-limiting example, assuming matched filtering (MF), the corresponding LS estimates are given by:

[symbol]

Other estimation schemes can be applied to obtain Ĥ_{y} and Ĥ_{z}, such as MMSE, zero-forcing (ZF), compressed sensing, high-resolution techniques, etc.

In some aspects, the estimated channel matrices Ĥ_{y} and Ĥ_{z}, i.e., describing the wireless channel along the azimuth and elevation domains are fed back to the network node 200 for further channel parameter estimation.

The network node 200 might then estimate the azimuth and elevation channel parameters. These parameters might by the network node 200 be used to design a two-dimensional precoder, or beamformer, consisting of azimuth and elevation components.

In some aspects, the network node 200 will first sense, or measure, the variations in the channel parameters in both azimuth and elevation domains with respect to previous estimates of the same quantities, and then decide whether the azimuth parameters, elevation parameter, or both the azimuth and elevation parameters are changing faster as compared to the previous estimates of the same quantities. The network node 200 might then based on this decide which operation mode should be used by the UE 300 and informing the UE 300 accordingly.

In some aspects, the UE 300 will apply de-spreading, for example by means of the factorization as given in Equation (5), to split the estimated azimuth and elevation matrices, i.e., \hat{X}_{y} and \hat{X}_{z}, without using any knowledge of the pilot sequences, and feed the estimates \hat{X}_{y} and \hat{X}_{z} back to the network node 200 for further channel parameter estimation. In this case, the estimation procedure at the UE 300 can be considered as a blind estimation.

In some aspects, when the network node 200 can estimate or predict the moving trajectory of the UE 300, the network node 200 can pre-design the pilot sequences.

The use of decoupled pilot sequences not only reduces the complexity in the pilot signal design (which is based on two independent pilot sequences), but also ultimately relaxes the constraints on the length of the pilot sequences as compared to the design of classical sequences used in 3GPP. Particularly, the design complexity decreases from O(M_{y}M_{z}) to O(M_{y}+M_{z}), whilst it largely reduces the computational complexity of the algorithmic operations from O(QT)³ to O((Q_{y}T_{y})+(Q_{z}T_{z})³. Here, T is the total length of the pilot block, and T_{y}, T_{z} are the lengths of azimuth and elevation domain pilot sequences, respectively.

Assume that M=16, M_{y}=4, M_{z}=4 and Q=16, Q_{y}=4, Q_{z}=4, with T=16 and T_{y}=4, T_{z}=4.

Therefore, using the proposed scheme, the design complexity of the proposed pilot sequence reduces from O(16) to O(8). In addition, the receiver computational complexity reduces from O(256)³ to O(32)³ which is 512 times smaller as compared to the classical state-of-the-art schemes, which decouple neither pilot signal transmission nor data reception processing into azimuth and elevation domains.

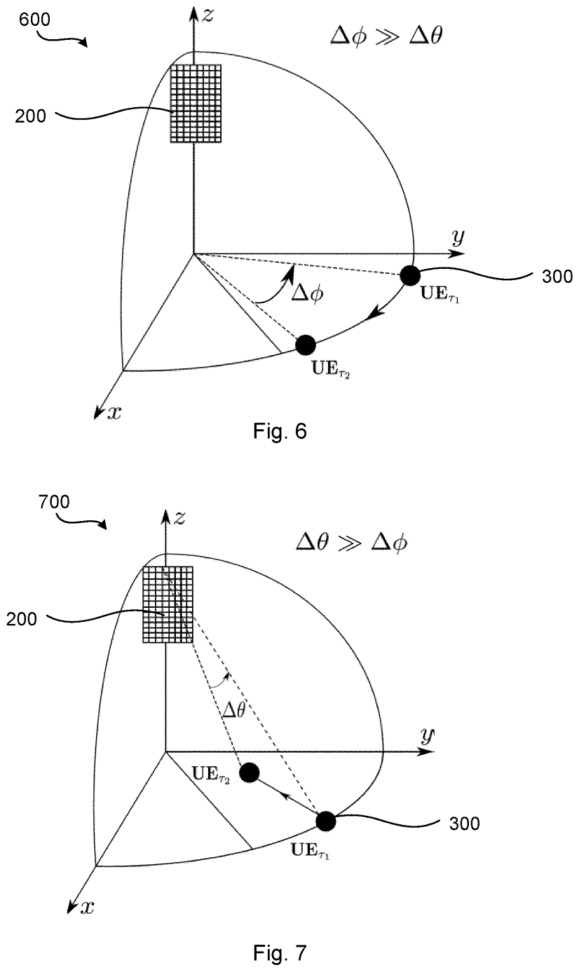

A first example will be disclosed next with reference to FIG. 6 and FIG. 7. In FIG. 6 and in FIG. 7 is illustrated a network node 200 and a UE 300 in a respective coordinate system 600, 700, where the UE 300 is moving from a source point to a destination point in the coordinate systems 600, 700. As shown in FIG. 6, the UE 300 starts moving from the source point at time τ₁ and reaches the destination point at time τ₂ During this movement, only the azimuth of departure angle φ is changed whilst the elevation of departure angle θ is constant. Similarly, as shown in FIG. 7, the UE 300 starts moving from the source point at time τ₁ along the elevation domain and reaches the destination point at time τ₂ During this movement, the elevation of departure angle θ is changed, whilst the azimuth of departure angle φ is constant. To make benefit of these scenarios, as well as other scenarios, the network node 200 will transmit pilot sequences more frequently along the changing domain to keep track of the variations in the channels, whilst transmitting data more frequently along the less varying domain, respectively.

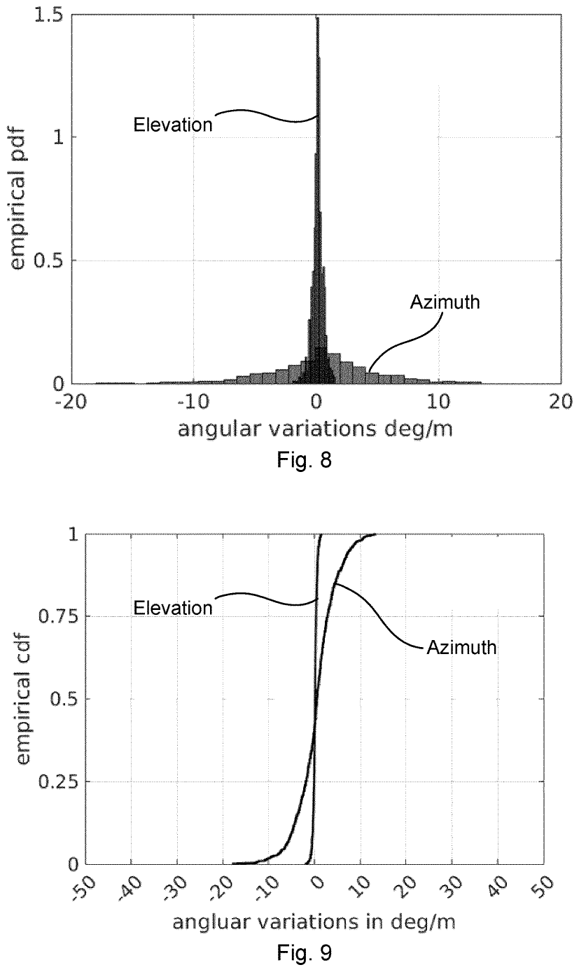

A second example will be disclosed next with reference to FIG. 8 and FIG. 9. This second example illustrates channel variations along azimuth and elevation domains. A Quadriga Channel Model (QuaDRiGa) is used to verify that the wireless channel can be factorized in two domains; the azimuth domain and the elevation domain. It is assumed that a UE 300 is moving from one point in the y-z domain. The angular variations along the elevation and azimuth domains are calculated and plotted as a histogram and a cumulative distribution function (CDF) as shown in FIG. 8 and FIG. 9. It is clear from these figures that during the movement of the UE 300 from one point to another point, the variations in the azimuth domain occur more frequently as compared to the elevation domain. This leads to the approximation H≈H_{y}⊗H_{z}. This further concludes that these scenarios can be exploited for joint pilot and data transmission, resulting in an increase of the overall system throughput.

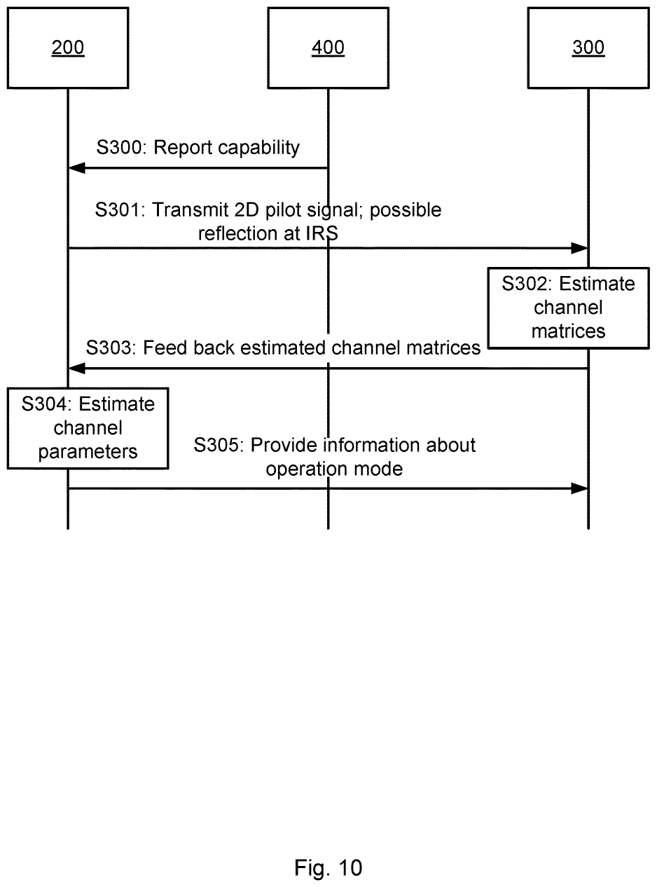

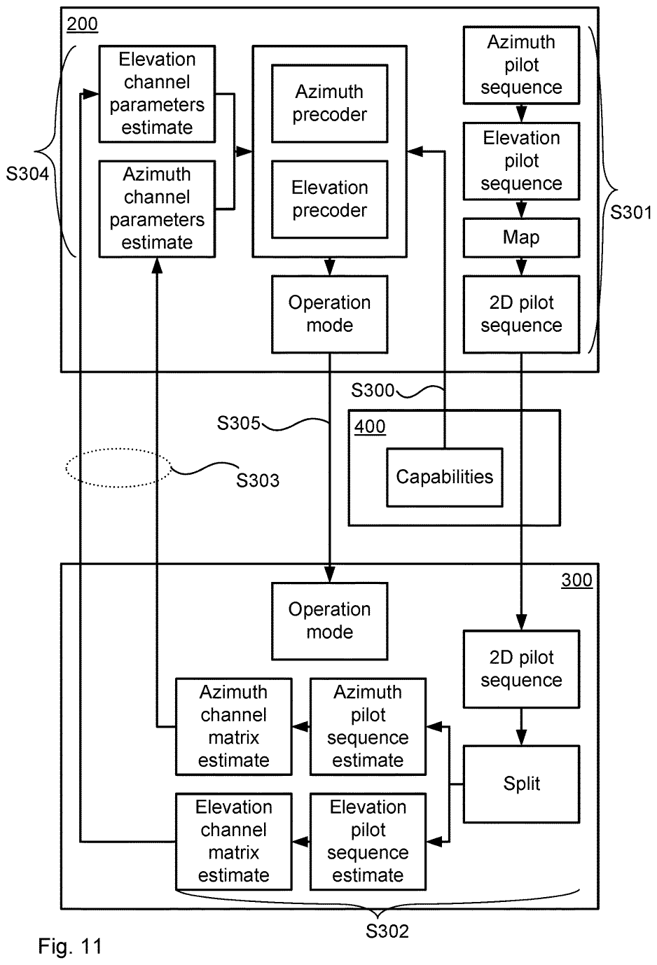

One particular embodiment for transmission and reception of two-dimensional pilot signals based on at least some of the above disclosed embodiments will now be disclosed in detail with reference to FIG. 10 and FIG. 11.

S300: The IRS 400 reports its capabilities to the network node 200.

S301: The network node 200 generates two independent pilot sequences, one in the azimuth domain and one in the elevation domains. The network node 200 maps the Kronecker product of these pilot sequences across the transmit antennas, and transmits a two-dimensional (2D) pilot signal towards the UE 300.

S302: The UE 300 receives the 2D pilot signal, possibly after reflection in the IRS 400. The UE 300 splits the received 2D pilot signal to estimate the azimuth and the elevation domain pilot sequences by solving a rank one matrix approximation problem. The UE 300 estimates the corresponding azimuth and elevation components, and thus channel matrices, of the wireless channel from the azimuth and the elevation domain pilot sequences and knowledge of the known pilot sequences.

S303: The UE 300 feeds the estimated channel matrices back to the network node 200.

S304: The network node 200 estimates the respective channel parameters. The network node 200 designs azimuth domain and elevation domain precoders based on the estimated channel parameters, and possibly also based on the received capabilities of the IRS 400.

S305: The network node 200 provides information to the UE 300 about which operation mode to use.

FIG. 12 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1610a (as in FIG. 16), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications (comm.) interface 220 for communications with other entities, functions, nodes, and devices, such as the UE 300. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230.

Other components, as well as the related functionality, of the network node 200 are omitted in order not to obscure the concepts presented herein.

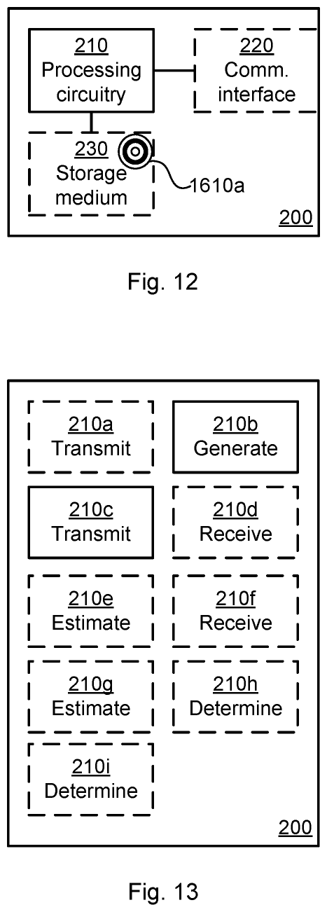

FIG. 13 schematically illustrates, in terms of a number of functional modules, the components of a network node 200 according to an embodiment. The network node 200 of FIG. 13 comprises a number of functional modules; a generate module 210b configured to perform step S104, and a transmit module 210c configured to perform step S106. The network node 200 of FIG. 13 may further comprise a number of optional transmit modules, such as any of a transmit module 210a configured to perform step S102, a receive module 210d configured to perform step S108, an estimate module 210e configured to perform step S110, a receive module 210f configured to perform step S112, an estimate module 210g configured to perform step S114, a determine module 210h configured to perform step S116, and a determine module 210i configured to perform step S118.

In general terms, each functional module 210a:210i may be implemented in hardware or in software. Preferably, one or more or all functional modules 210a:210i may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210i and to execute these instructions, thereby performing any steps of the network node 200 as disclosed herein.

The network node 200 may be provided as a standalone device or as a part of at least one further device. For example, the network node 200 may be provided in a node of a (radio) access network or in a node of a core network. Alternatively, functionality of the network node 200 may be distributed between at least two devices, or nodes. These at least two nodes, or devices, may either be part of the same network part (such as the (radio) access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 12 the processing circuitry 210 may be distributed among a plurality of devices, or nodes. The same applies to the functional modules 210a:210i of FIG. 13 and the computer program 1620a of FIG. 16.

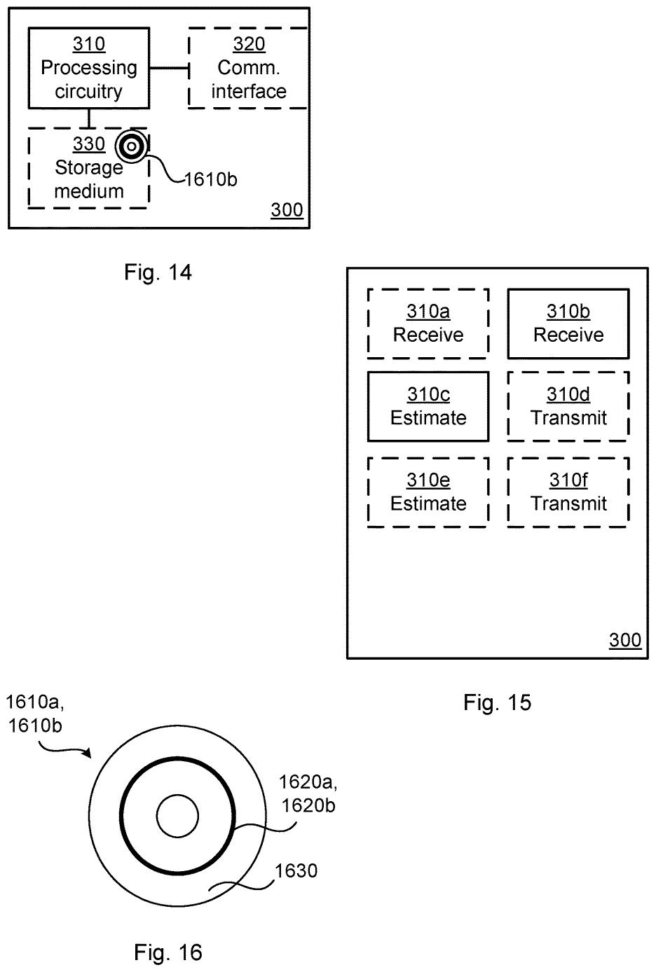

FIG. 14 schematically illustrates, in terms of a number of functional units, the components of a UE 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1610b (as in FIG. 16), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300 to perform a set of operations, or steps, as disclosed above. For example, the storage medium 330 may store the set of operations, and the processing circuitry 310 may be configured to retrieve the set of operations from the storage medium 330 to cause the UE 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300 may further comprise a communications interface 320 for communications with other entities, functions, nods, and devices, such as the network node 200. As such the communications interface 320 may comprise one or more transmitters and receivers, comprising analogue and digital components.

The processing circuitry 310 controls the general operation of the UE 300 e.g. by sending data and control signals to the communications interface 320 and the storage medium 330, by receiving data and reports from the communications interface 320, and by retrieving data and instructions from the storage medium 330. Other components, as well as the related functionality, of the UE 300 are omitted in order not to obscure the concepts presented herein.

FIG. 15 schematically illustrates, in terms of a number of functional modules, the components of a UE 300 according to an embodiment. The UE 300 of FIG. 15 comprises a number of functional modules; a receive module 310b configured to perform step S204, and an estimate module 310c configured to perform step S206. The UE 300 of FIG. 15 may further comprise a number of optional functional modules, such as any of a receive module 310a configured to perform step S202, a transmit module 310d configured to perform step S208, an estimate module 310e configured to perform step S210, and a transmit module 310f configured to perform step S212.

In general terms, each functional module 310a:310f may be implemented in hardware or in software. Preferably, one or more or all functional modules 310a:310f may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310f and to execute these instructions, thereby performing any steps of the UE 300 as disclosed herein.

FIG. 16 shows one example of a computer program product 1610a, 1610b comprising computer readable means 1630. On this computer readable means 1630, a computer program 1620a can be stored, which computer program 1620a can cause the processing circuitry 210 and thereto operatively coupled entities and devices, such as the communications interface 220 and the storage medium 230, to execute methods according to embodiments described herein. The computer program 1620a and/or computer program product 1610a may thus provide means for performing any steps of the network node 200 as herein disclosed. On this computer readable means 1630, a computer program 1620b can be stored, which computer program 1620b can cause the processing circuitry 310 and thereto operatively coupled entities and devices, such as the communications interface 320 and the storage medium 330, to execute methods according to embodiments described herein. The computer program 1620b and/or computer program product 1610b may thus provide means for performing any steps of the UE 300 as herein disclosed.

In the example of FIG. 16, the computer program product 1610a, 1610b is illustrated as an optical disc, such as a CD (compact disc) or a DVD (digital versatile disc) or a Blu-Ray disc. The computer program product 1610a, 1610b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620a, 1620b is here schematically shown as a track on the depicted optical disk, the computer program 1620a, 1620b can be stored in any way which is suitable for the computer program product 1610a, 1610b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for transmitting a two-dimensional pilot signal, wherein the method is performed by a network node, and wherein the method comprises:
generating the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y; and
transmitting the two-dimensional pilot signal over the air.

2. The method according to claim 1, wherein the azimuth domain pilot sequence S_{y} is designed independently from the elevation domain pilot sequence S_{z}.

3. The method according to claim 1, wherein the two-dimensional pilot signal S is transmitted towards a user equipment, UE, and wherein the method further comprises:
transmitting a control signal to configure the UE with the azimuth domain pilot sequence S_{y} and the elevation domain pilot sequence S_{z} prior to transmitting the two-dimensional pilot signal.

4. The method according to claim 1, wherein the two-dimensional pilot signal S is transmitted towards a user equipment, UE, and wherein the method further comprises:
receiving an estimated azimuth domain channel component Ĥ_{y} and an estimated elevation domain channel component Ĥ_{z} over the air from the UE.

5. The method according to claim 4, wherein the method further comprises:
estimating an azimuth domain channel component Ĥ_{y} from the estimated azimuth domain pilot sequence \hat{X}_{y} and an elevation domain channel component Ĥ_{z} from the estimated elevation domain pilot sequence \hat{X}_{z}.

6. The method according to claim 1, wherein the two-dimensional pilot signal S is transmitted towards a user equipment, UE, and wherein the method further comprises:
receiving an estimated azimuth domain channel component Ĥ_{y} and an estimated elevation domain channel component Ĥ_{z} over the air from the UE.

7. The method according to claim 5, wherein the method further comprises:
estimating azimuth domain channel parameters from the estimated azimuth domain channel component Ĥ_{y} and estimating elevation domain channel parameters from the estimated elevation domain channel component Ĥ_{z}.

8. The method according to claim 7, wherein the method further comprises:
determining a two-dimensional precoder with an azimuth component determined from the estimated azimuth domain channel parameters and an elevation component determined from the estimated elevation domain channel parameters.

9. (canceled)

10. The method according to claim 1, wherein the two-dimensional pilot signal S is generated by taking a Kronecker product between the azimuth domain pilot sequence S_{y} and the elevation domain pilot sequence S_{z}.

11. The method according to claim 10, wherein the two-dimensional pilot signal S is transmitted from a two-dimensional antenna comprising antenna element arranged in rows and columns, and wherein the two-dimensional pilot signal s_{y}⁽ⁱ⁾⊗s_{z}^{(j)} is transmitted at antenna element (i, j), where s_{y}⁽ⁱ⁾∈S_{y} is the azimuth domain pilot sequence for all antenna elements in row i of the two-dimensional antenna, where s_{z}^{(j)}∈S_{z} is the elevation domain pilot sequence for all antenna elements in column j of the two-dimensional antenna, and where ‘⊗’ denotes the Kronecker product operator.

12. A method for receiving a two-dimensional pilot signal, wherein the method is performed by a user equipment, UE, and wherein the method comprises:
receiving the two-dimensional pilot signal X over the air from a network node; and
de-spreading the two-dimensional pilot signal X and estimating a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

13. The method according to claim 12, wherein the method further comprises:
receiving a control signal from the network node to configure the UE with a transmitted azimuth domain pilot sequence S_{y} and a transmitted elevation domain pilot sequence S_{z} prior to receiving the two-dimensional pilot signal.

14. The method according to claim 12, wherein the method further comprises:
transmitting the estimated received azimuth domain pilot sequence \hat{X}_{y} and the estimated received elevation domain pilot sequence \hat{X}_{z} over the air to the network node.

15. The method according to claim 12, wherein the method further comprises:
estimating an azimuth domain channel component Ĥ_{y} from the estimated received azimuth domain pilot sequence \hat{X}_{y} and an elevation domain channel component Ĥ_{z} from the estimated received elevation domain pilot sequence \hat{X}_{z}.

16. (canceled)

17. (canceled)

18. The method according to claim 12, wherein the azimuth domain pilot sequence \hat{X}_{y} and the elevation domain pilot sequence \hat{X}_{z} are estimated from the two-dimensional pilot signal X by Kronecker factorization of the two-dimensional pilot signal X.

19. The method according to claim 18, wherein the Kronecker factorization is performed by solving a Kronecker factorization problem formulated as: [symbol]
where ‘⊗’ denotes the Kronecker product operator.

20. A network node for transmitting a two-dimensional pilot signal, the network node comprising processing circuitry, the processing circuitry being configured to cause the network node to:
generate the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y; and
transmit the two-dimensional pilot signal over the air.

21. (canceled)

22. (canceled)

23. A user equipment, UE, for receiving a two-dimensional pilot signal, the UE comprising processing circuitry, the processing circuitry being configured to cause the UE to:
receive the two-dimensional pilot signal X over the air from a network node; and
de-spread the two-dimensional pilot signal X and estimate a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

24. (canceled)

25. (canceled)

26. A computer program product for transmitting a two-dimensional pilot signal, the computer program product comprising a non-transitory computer readable medium storing computer code which, when run on processing circuitry of a network node, causes the network node to:
generate the two-dimensional pilot signal S by spreading an azimuth domain pilot sequence S_{y} with an elevation domain pilot sequence S_{z} in the elevation domain z and spreading the elevation domain pilot sequence S_{z} with the azimuth domain pilot sequence S_{y} in the azimuth domain y; and
transmit the two-dimensional pilot signal over the air.

27. A computer program product for receiving a two-dimensional pilot signal, the computer program product comprising a non-transitory computer readable medium storing computer code which, when run on processing circuitry of a user equipment, UE, causes the UE to:
receive the two-dimensional pilot signal X over the air from a network node; and
de-spread the two-dimensional pilot signal X and estimate a received azimuth domain pilot sequence \hat{X}_{y} and a received elevation domain pilot sequence \hat{X}_{z} from the two-dimensional pilot signal X by solving a rank one matrix approximation problem for the two-dimensional pilot signal X.

28. (canceled)
